(19) United States
(12) Patent Application Publication
(10) Pub. No.: US 2009/0177588 A1
(43) Pub. Date: Jul. 9, 2009

(54) SYSTEM AND METHOD OF DETERMINING PRICING AND SPONSORSHIP OPTIMIZATION FOR BRAND PROMOTERS AND SOCIAL PUBLISHERS

(75) Inventor: Joseph John Marchese, Los Angeles, CA (US)

Correspondence Address: KNOBBE MARTENS OLSON & BEAR LLP, 2040 MAIN STREET, FOURTEENTH FLOOR, IRVINE, CA, 92614, US

(73) Assignee: ARCHETYPE MEDIA INC., Camarillo, CA (US)

(21) Appl. No.: 12/265,082

(22) Filed: Nov. 5, 2008

Related U.S. Application Data
(60) Provisional application No. 60/985,589, filed on Nov. 5, 2007.

(51) Int. Cl. G06Q 30/00; G06Q 10/00; G06F 17/30; G06F 17/40

(52) U.S. Cl. 705/80; 705/10; 705/14; 707/104.1; 707/E17.044

(57) ABSTRACT

Systems and methods for quantifying points of value in a personality relevant publishing environment are disclosed. These systems and method determine and account for the value that a brand campaign provides to brand promoters when the brand campaign is delivered within the social content of social publishers.

### CROSS-REFERENCE TO RELATED APPLICATIONS

This application claims the benefit of U.S. Provisional Patent Application No. 60/985,589, filed on Nov. 5, 2007, the disclosure of which is incorporated by reference herein in its entirety.

### BACKGROUND OF THE INVENTION

1. Field of the Invention

The application relates to computer network systems. In particular, this application is related to computerized systems and methods which provide the ability to quickly and accurately identify and quantify points of value in the relationship between a brand promoter and a social publisher.

2. Description of the Related Technology

Existing pricing systems which are used to value the relationship between a brand promoter and a social network are inadequate. The existing pricing systems in social network advertising systems typically value the relationship between a brand and a social publisher by measuring page impressions (such as, for example, the number of times the brand advertisement is displayed on a web page of the social publisher), and/or click-through rate (the rate at which visitors exposed to a particular advertisement actually “click” on the advertisement). They do not effectively identify or account for more nuanced aspects of the relationship created between a brand promoter and a social publisher when brand advertisements are presented within the social publisher's social media content.

### BRIEF DESCRIPTION OF THE DRAWINGS

FIG. 1 is a block diagram of a network environment suitable for implementing various embodiments described herein.

FIG. 2 is a flowchart providing one example of an interaction between a brand promoter and a social publisher.

FIG. 3 is a more detailed flowchart of a portion of the process shown in FIG. 2.

FIG. 4 is a flowchart showing an example of determining a brand selection rate.

FIG. 5 is an example of a report that may be generated based at least in part on the process described in FIG. 2.

FIG. 6 is an example of a report that may be generated based at least in part on the process described in FIG. 2.

FIG. 7 is an example of a report that may be generated based at least in part on the process described in FIG. 2.

FIG. 8 is an example of a report that may be generated based at least in part on the process described in FIG. 2.

FIG. 9 is a flowchart of a method for optimizing brand sponsorship offers to social publishers.

### SUMMARY OF CERTAIN INVENTIVE ASPECTS

The system, method, and devices of the present invention each have several aspects, no single one of which is solely responsible for its desirable attributes. Without limiting the scope of this invention, several of its features will now be discussed briefly.

In a first aspect, a computer-implemented method of quantifying points of value in a personality relevant publishing environment is provided. The method comprises identifying a plurality of social publishers each having social characteristics of interest to a brand promoter and sending a first message to each of the social publishers, wherein the message comprises data indicative of the brand promoter and an offer to provide details of a brand sponsorship opportunity to each of the social publishers. Data is stored which is indicative of the first message, and the data indicative of the first message includes the identity of the social publisher receiving the message, social characteristics of the social publisher receiving the message, and the brand associated with the brand sponsorship opportunity associated with the first message. The method further includes receiving and storing data indicative of responses the social publishers to the first message, wherein the responses to the first message include data indicative of an acceptance or declination of the offer to provide details of the brand sponsorship opportunity, and sending a second message to those of the social publishers whose response to the first message includes an acceptance of the offer to provide details of the brand sponsorship opportunity, wherein the second message comprises data indicative of the details of the brand sponsorship opportunity. Data indicative of the second message is stored and the data indicative of the second message includes the identity of the social publisher and the details of the second offer. The method further includes receiving and storing data indicative of responses by the social publishers to the second message, wherein the responses to the second message include data indicative of an acceptance or declination of brand sponsorship opportunity.

In a second aspect, a computer-readable medium having computer-executable instructions stored thereon which, when executed, cause a computing device to perform a method of quantifying points of value in a personality relevant publishing environment is provided. The method comprises identifying a plurality of social publishers each having social characteristics of interest to a brand promoter and sending a first message to each of the social publishers, wherein the message comprises data indicative of the brand promoter and an offer to provide details of a brand sponsorship opportunity to each of the social publishers. Data is stored which is indicative of the first message, and the data indicative of the first message includes the identity of the social publisher receiving the message, social characteristics of the social publisher receiving the message, and the brand associated with the brand sponsorship opportunity associated with the first message. The method further includes receiving and storing data indicative of responses the social publishers to the first message, wherein the responses to the first message include data indicative of an acceptance or declination of the offer to provide details of the brand sponsorship opportunity, and sending a second message to those of the social publishers whose response to the first message includes an acceptance of the offer to provide details of the brand sponsorship opportunity, wherein the second message comprises data indicative of the details of the brand sponsorship opportunity. Data indicative of the second message is stored and the data indicative of the second message includes the identity of the social publisher and the details of the second offer. The method further includes receiving and storing data indicative of responses by the social publishers to the second message, wherein the responses to the second message include data indicative of an acceptance or declination of brand sponsorship opportunity.

### DETAILED DESCRIPTION OF CERTAIN INVENTIVE EMBODIMENTS

The inventor has recognized that computer-implemented social networking advertisement systems are designed to focus solely on performance-based actions (such as brand impressions) and do not fully account for the fact that all impressions within a social media setting do not provide equal value to the brand promoters and that there is significant value to brand promoters in the reporting of all interactions with social media publishers preceding and leading to social media impressions. As such, systems and methods are described herein which provide the ability to determine and account for the value that a brand campaign provides to brand promoters when delivered within the social content of social publishers.

As used herein, a social publisher may be any person, group, or organization that produces, creates and makes available social content. One example of a social publisher may be a user or member of a social network. Another example of a social publisher may be a proprietor of a website or a web log (blog). Social networks may comprise one or more social networking websites which may typically offer an interactive network that includes various combinations of blogs, user groups, photos and e-mail, music, video, art, commentary or some other content. Users typically sign up to use the social network and maintain personal websites that project an image and ostensibly reflect “who they are.” Users of social networking websites may be referred to as social publishers. Typically, the website maintained by a social publisher includes social content customized according to the social publisher's preferences and tastes and their desire to “brand” themselves.

As used herein, social content may be any content that is created by a social publisher. Social content may also be referred to as “user-generated content.” An example of social content may be content produced that creates an online image for the social publisher. Social content may take the form of text, graphics, video, audio or any other electronic form. Social content may also be presented in the form of a blog, an online journal, an e-mail message, a photograph, an illustration, a sound file, a video file, or some other combination of electronic content.

A brand may be a symbolic embodiment of all information connected with a product or service. A brand typically includes a name, logo, and other visual or audio elements such as images, sounds, or symbols. A brand may also encompass the set of expectations in the mind of the consumer which are typically associated with a product or service. A “brand promoter” is any person, group, organization, or other entity which seeks to enhance the value of a brand.

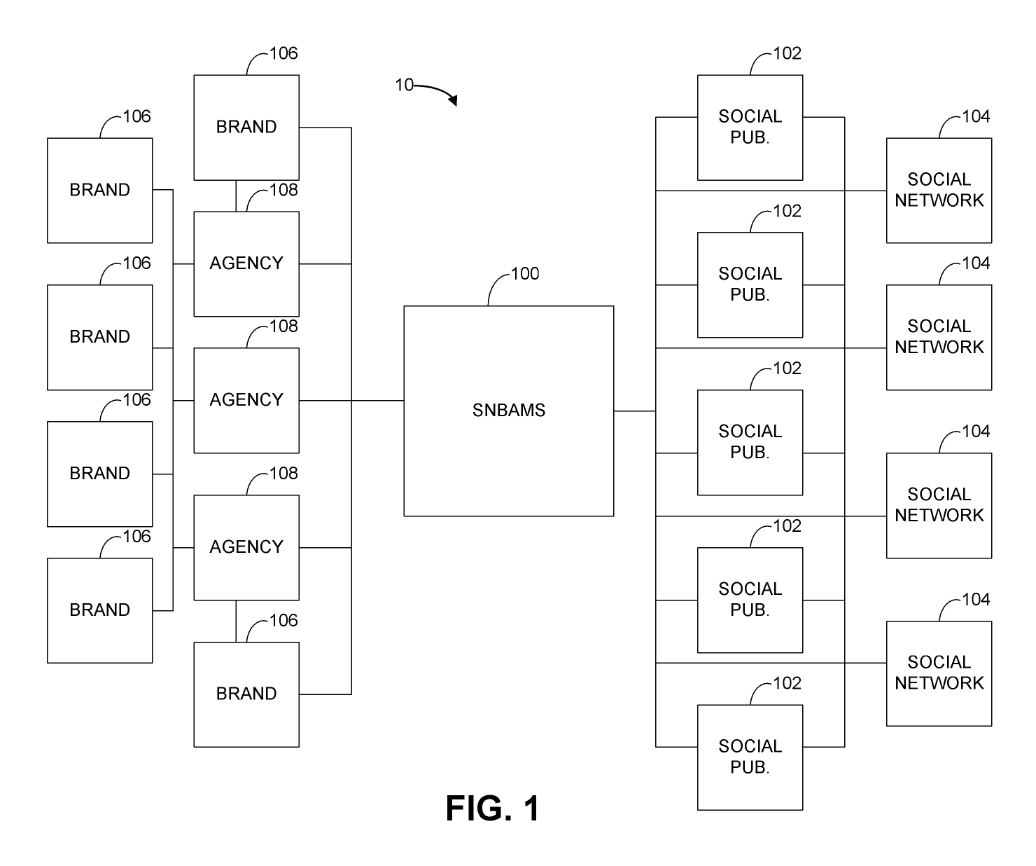

FIG. 1 is a block diagram illustrating an example of a networking environment 10 suitable for practicing various embodiments described herein. The networking environment 10 may be an internet-based environment, with various computer systems electronically communicating via defined protocols such as TCP/IP. As shown in FIG. 1, the environment 10 may include a social networking brand advertising management system (SNBAMS) 100. In some embodiments, SNBAMS 100 may include functionality similar to that of a publisher relevant advertising module as described in co-assigned U.S. patent application Ser. No. 11/752,185, filed on May 22, 2007, the entire disclosure of which is hereby incorporated by reference in its entirety. As will be described in detail below, the SNBAMS 100 creates a marketplace through which other systems and entities may interact to deliver advertising services in social networking environments.

Also connected to the network environment 10, are social publisher systems 102. The social publishers systems 102 are typically computer systems operated by social publishers. The social publisher systems 102 may include web browsing software which allows the social publisher to connect to the SNBAMS 100 via the network 10. The social publisher systems may use other types of network-capable software to communicate with the SNBAMS 100.

The network environment 10 also includes social network systems 104. The social network systems 104 are also in communication with the social publishers 102. As is well-known in the art, the social publishers typically access the social network systems 104 via the social publisher systems 102 to generate and publish their social content on the social network systems 104. As shown in FIG. 1, the various social publishers systems 102 may communicate with more than one social network system 104 via the network 10. This is because many social publishers maintain social networking accounts in more than one specific social network.

The network environment 10 also includes brand computer systems 106. The brand computer systems 106 are computer systems which are associated with brands which are advertised in on the social network 104 via the SNBAMS 100. The brand computer systems 106 may be computer systems owned by companies whose wish to advertise their brands. In some embodiments, the brand computers systems communicate with the SNBAMS 100 directly, while in other embodiments, the brand systems 106 may communicate with the agency systems 108, which in turn communicate with the SNBAMS 100. The agency systems 108 are computer systems associated with entities charged with providing advertising services to the brands. These entities may include advertising agencies, creative consultant, or some other entity retained by the brand owners to help enhance the value of their brands. A brand system 106 may communicate with more than one agency system 108, and it may also communicate both with agencies 108 and the SNBAMS 100 directly. Although the SNBAMS 100 is shown in FIG. 1 as existing separately from the other systems shown therein, one of skill in the art will appreciate that the SNBAMS 100 may form an integrated system with one or more of the other computer systems shown in FIG. 1. For example, one or more of the social networks 104 may provide the SNBAMS 100 as an advertising module of the social networking system 104. Other types of integration may be provided.

In certain embodiments, the SNBAMS 100 is configured to provide a marketplace which can be accessed by brand promoters (or their proxies) to reach consumers via brand advertising content provided within the social content of social publishers via the social network systems 104. In particular, the SNBAMS 100 may be configured to provide an operating environment in which various value-generating events are created which provide benefit to both brand promoters and social publishers alike. The SNBAMS 100 allows brand promoters to target for sponsorship social publishers who project an image that effectively represents, reinforces, or enhances the brand's image. Utilizing the brand systems 106 and/or agency systems 108, the brand promoters may specify social traits of social publishers (which may be derived from self-assessments by the social publisher) with whom they wish to associate their brand. Brand promoters may further specify a level of social influence (which may be derived from social activity of social publishers) for those social publishers with whom they would like to associate their brand. Brand promoters may further specify demographic attributes for the social publishers with whom they would like to associate their brand.

Once the brand promoter has defined the desirable social attributes (social traits, social influence, and demographic attributes) the brand promoter may bid to have their sponsorship offers distributed to relevant social publishers. The SNBAMS 100 may be configured to select social publishers that fit (either exactly, or to some degree of proximity) the specified social attributes and offer the social publishers the opportunity to be sponsored (e.g. receive compensation or some benefit) by the brand promoter as an inducement to display the brand within their social content.

The compensation provided to the social publisher may take various forms. The benefit may simply include an ability to influence the brand content displayed within their social content. In other embodiments, the social publisher may receive some form of brand specific perk or access. For example, the social publisher may receive promotional items from the brand promoter or access to promotional events. The social publisher may receive monetary compensation. The SNBAMS 100 may include a brand promoter management (BPM) module which may be accessed by brand systems 106 and/or agency systems 108 to allow brand promoters to create and manage advertising campaigns for their brands.

The BPM module may include one or more software processes which collect relevant data from brand promoters. This data may include data such as a user name and password used for online authentication. The data may further include contact information. Contact information for brand promoters may include a corporate address, email, phone number, and other contact information. The contact information may be used to inform brand promoters of events affecting various campaigns, such as expiration of ongoing campaigns or billing issues in the SNBAMS 100. Standard billing information may also be collected from brand promoters via a collection module. The billing information may include data that allows the system to receive payment from brand promoters and notify brand promoters of payments made and payments due.

The BPM module may also include a campaign creation/management module which may be accessed by brand systems 106 and/or agency systems 108 define advertising campaigns within the SNBAMS 100. The campaign creation/management module may store or utilize target attribute data which includes various social attributes. In one embodiment, the attributes may be publisher types. In another embodiment, the attributes may include social tendencies, e.g., athletes, skaters, ravers, artists, clubbers, etc. The target attribute data may also include geographic attributes such as regions, cities, states, or other geographic delineations. Target attributes may also include age ranges, sex, income level, or some other demographic or psychographic attribute. The campaign creation/management module may also include brand art data storage which allows the brand promoters to upload brand art into the SNBAMS 100 and store it for use in brand campaigns created within the system.

The SNBAMS 100 may also include an online persona definition module which is accessed by social publisher systems 102 and allows social publishers to create and/or define their online persona or profile. The created profile is then used by the SNBAMS 100 to match social publishers with brand promoters seeking to sponsor social publishers having specified social attributes.

The online persona definition module may be software configured to present social publishers who access the SNBAMS 100 with a series of questions. The responses given by the social publisher may be used by the SNBAMS 100 to generate a social profile for each social publisher. Various techniques for defining the social characteristics of the social publishers may be utilized. The social publishers may be given a self-assessment questionnaire. The questions may relate to various publisher lifestyle, leisure and product preferences. The answers given by the social publishers may be stored as social publisher personality preference data. In one embodiment, the system may present questions in the form of a Myers-Briggs-like test which helps to define personality traits of the social publisher. The online persona definition module may also be configured to receive identity data from the social publisher. The identity data may include information such as the name, hometown, high school, college, or other personal data. The online persona definition module may also be configured to receive social association data. The social association data may include information relating to the social activity of the social publisher in the social network. For example, the social association data for a social publisher may include their “friends” within the social network, their incoming links, their incoming messages, or some other data.

The online persona definition module may create an online persona definition for each social publisher based on the received personality preferences data, the identity data, and/or the social associations data. In one embodiment, the online persona is generated from this data to assign values for each social publisher in some or all of the attributes that are available to brand promoters as target attributes which may be specified by the brand promoters. Thus, the generated online persona of each social publisher may be compared against the target attributes of brand promoters to determine whether the online persona of the publisher is a match.

The SNBAMS may also be configured to measure the social influence of social publishers. These measurements may be provided by a social influence measurement module. The social influence measurement module may be a software module that is configured to analyze various data about each social publisher to determine their degree of influence within the social network. The social influence measurement module may take the form of an application module or sub-module which receives various pieces of data and analyzes them to generate a social influence value. Those social publishers having greater social influence values will typically be more desirable for brand promoters as spokespersons for their brands. In one embodiment, the social influence measurement value is generated by gathering data regarding various measurements of social activity within the social network. The social influence measurement module may be configured to analyze each social publisher within the network periodically to recalculate their social influence value, which may change over time.

In determining a social influence measurement for a social publisher, the social influence measurement module may receive incoming traffic data for each social publisher. This data may simply be a measurement of the number of page views on the social content of the social publishers, or it may also include the referring pages. The social influence measurement module may also measure the number of incoming links for each social publisher to provide an indication of their popularity within the social network. Another metric that may be utilized by the social influence measurement module is incoming message data. This data may include the number of incoming text or e-mail messages that the social publisher receives over the social network. This data may also include the social influence measurement, if available, of the persons sending the messages to the social publisher. Thus, if the social publisher is receiving messages from more influential users within the network, it may be safe to presume that the social publisher also carries a degree of influence within the community. Because social networks suffer when the content of social publishers is stagnant or stale, the social influence measurement may measure the frequency of updates of the social publisher's social content. A social publisher that adds new content to his website frequently will generally receive a higher value than a social publisher that updates only periodically. In some embodiments, the module may be configured to detect social publishers who attempt to generate in increased value by spamming or by generating some other form of valueless content. The social influence measurement module may further include social publisher terms of service (TOS) violation data. TOS violation data is data that relates to violations of the terms of service of the social network or of the SNBAMS 100 by social publishers.

The social influence measurement module may take all of the data described above and use the data to create a social influence ranking or measurement for each social publisher associated with the SNBAMS 100. In one embodiment, the module ranks each social publisher by each of the categories of data on a scale of 1-10. By way of example, a social publisher that is in the top 10 percent of incoming traffic will receive a 10 ranking in that category. However, if that same publisher does not have many “friends” in the social network, and is only in the top 50 percent of social publishers, they may receive a 5 ranking for that category. Similarly, if a social publisher is in the top ten percent of incoming links they may receive a 10 ranking in that category. Once a ranking has been determined for each of the different metrics, they may be combined or averaged into a composite social influence value or level. The metrics may be assigned each the same weight in determining the composite social influence value, or they may be assigned different weights. Thus, each social publisher may receive a regularly updated social influence value which may be used to determine brand sponsorship offers for which they might be eligible.

The SNBAMS 100 may also include a brand-social publisher association module which is configured to match up social publishers with brands based on attributes of the social publishers as defined by the online persona definition module and the target attributes specified by brand promoters for their campaigns. The brand-social publisher association module receives target attribute data for active brand campaigns from the brand systems 106 and/or the agency systems 108. The target attribute data may have been defined by the brand promoter when defining or creating the brand campaign as described above. The brand-social publisher association module also may include or access attribute data related to the social publishers which may include the data generated by the online persona definition process described above. This data may include a social influence ranking generated by the social influence measurement module. Brand promoters may specify that they want their brand to be associated only with those social publishers that have not had any terms of service violations recorded in the SNBAMS 100 and/or the social networking systems 104.

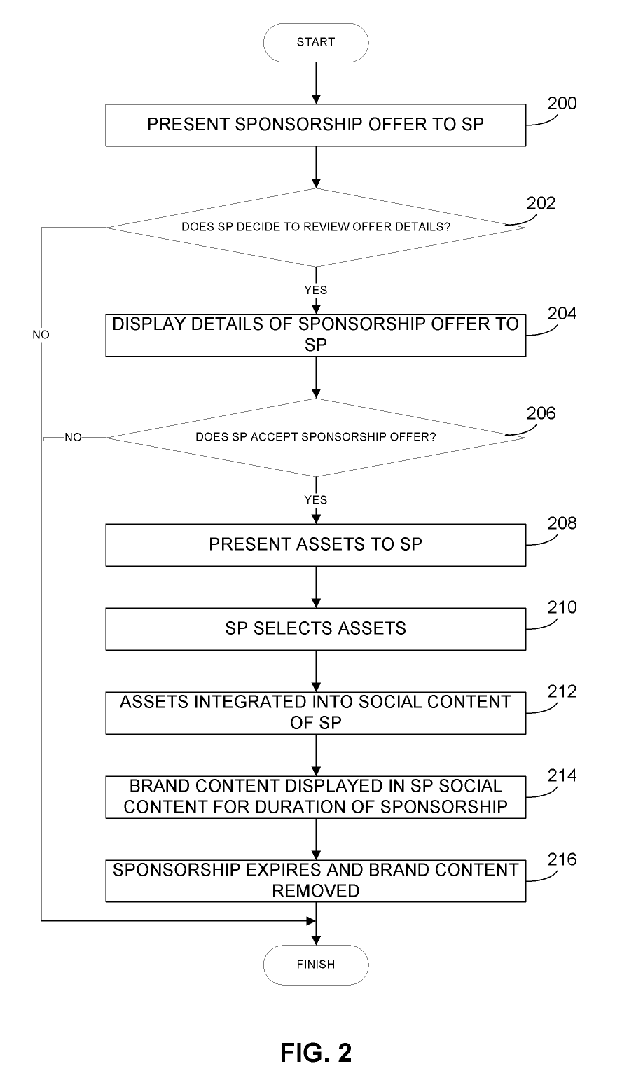

As noted above, various embodiments provide systems and method for determining and accounting for the value a brand campaign provides to brand promoters when delivered within the social content of social publishers. FIG. 2 is a flowchart providing one example of an interaction between a brand promoter and a social publisher via the SNBAMS 100. The process begins at the initiation block and immediately moves to block 200, where the brand's sponsorship offer is presented to the social publisher. The sponsorship offer may include creative content and an offer of compensation. The creative content typically includes brand art which would be displayed in the social publisher's social content if the sponsorship offer is selected. The brand art may be any form of electronic data which is used to promote the brand. The offer of compensation may be a promotional offer for discounted products (possibly associated with the brand), bonus points, money, or some other form of compensation. Initially, the sponsorship offer is presented with limited detail. For example, the initial display of the sponsorship offer may only include the name of the brand offering the sponsorship, and not display more detailed items such as the specifics of the sponsorship offer including the brand art and/or the offer of compensation.

Next, the process moves to decision block 202, where the social publisher determines whether to review the details of the sponsorship offer. If the social publisher does not review the details of the sponsorship offer, then process terminates. If the social publisher chooses to review the details of the sponsorship offer, then the process moves to block 204, where the details of the sponsorship offer are displayed to the social publisher. Once the details of the sponsorship offer have been displayed to the social publisher, the process moves to decision block 206, where the social publisher determines whether to accept the sponsorship offer from the brand promoter.

If the social publisher declines the sponsorship offer, the process terminates. If the social publisher accepts the offer from the brand promoter, the process moves to block 208, where the user is presented with a choice of various assets (an asset is an element of a sponsorship offer) provided by the brand. These assets may include various creative selections available to the social publisher such as different versions of brand art, widgets, and/or video to display within their social content. The assets may also include different offers of compensation which may be selected by the social publisher.

Next, at block 210, the social publisher selects the assets from the sponsorship offer. The process then moves to block 212, where the SNBAMS 100 integrates the selected assets into the social content of the social publisher. This process may involve the SNBAMS 100 sending the data to the social network systems 104, or possibly sending the data to the social publisher system 102 for integration into the social publisher's content. After the brand content has been integrated into the social publisher's social content, the brand advertisement is displayed to other users within the social network of the social publisher at block 214 for the duration of the sponsorship. Upon expiration of the sponsorship at block 216, the process terminates as shown in FIG. 2.

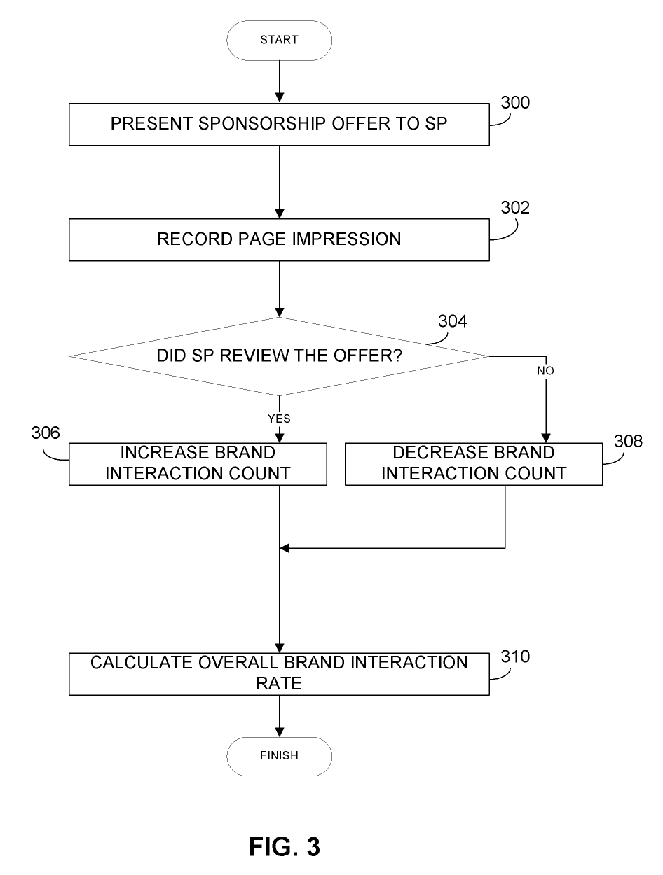

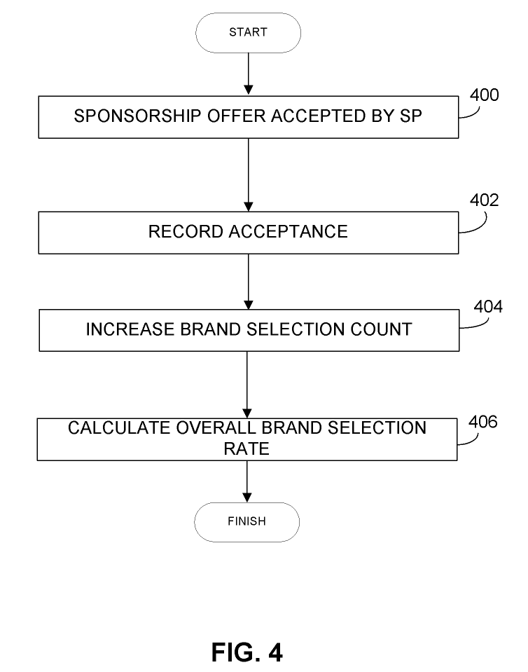

In exchange for providing the brand promoters with a way to find relevant social publishers for the brand advertising, the SNBAMS 100 may be configured to charge a fee to the brand promoters for the service. As noted above, existing social networking advertising systems do not adequately account for potential value provided to the brand promoters by a system such as SNBAMS 100. FIGS. 3 and 4 are flowcharts illustrating examples of how the SNBAMS 100 can determine a relative value to the brand promoter that is associated with a particular event or aspect of the interaction between the brand promoter and one or more social publishers within the SNBAMS 100.

In some embodiments, the SNBAMS 100 may be configured to identify a value with respect to various events in the process described in connection with FIG. 2. In certain particular aspects, the SNBAMS 100 may determine a price or value to the brand based on the level of brand interaction between social publishers and the brand as described in steps 200 and 202 of FIG. 2. The SNBAMS 100 may derive value from the brand/social publisher interaction in at least two distinct ways at this point in the process. First, there is value to the brand promoter based on the brand having been exposed to a social publisher having social attributes desirable to and/or specified by the brand promoter. This exposure is valuable because the exposure is, in effect, a consumer brand impression. Second, the SNBAMS 100 may be configured to analyze how the social publisher (who is also a consumer) reacted to the brand's sponsorship offer. This additional data allows brands to gain an understanding of how a consumer having its specified attributes initially reacted to the brand offer. Referring now to FIG. 3, a flowchart is provided which illustrates how the SNBAMS 100 may be configured to determine price or value of certain events. In particular, the SNBAMS 100 may be configured to determine the value associated with the presentation and review of the sponsorship offer as described in blocks 200 and 202 of FIG. 2.

The process begins at the initiation block and immediately proceeds to block 300, where the sponsorship offer is presented to the social publisher having attributes selected by the brand promoter. Next, at block 302, the SNBAMS 100 records a page impression of the brand because the brand has been exposed to a consumer having social attributes specified by the brand promoter. The process then moves to decision block 304 where the SNBAMS 100 determines if the social publisher reviewed the offer or if the social publisher merely skipped the brand sponsorship offer and proceeded to review other offers without reviewing the details of the brand sponsorship offer. If the social publisher did not review the brand sponsorship offer, the SNBAMS will record that data at block 306. If the social publisher reviewed the sponsorship offer, the SNBAMS will record that data at block 308.

From either block 306 or 308, the process then moves to block 310, where the SNBAMS 100 calculates an updated brand interaction rate and then terminates. The brand interaction rate is the rate at which social publishers interact with a brand by seeking more details about a sponsorship offer presented to them by the SNBAMS 100 through their social publisher systems 102. This data may be valuable to brand promoters because it provides data about of how social publishers are immediately reacting to the brand being promoted. If the brand interaction rate is very low, it may indicate that the brand is not interesting to consumers having the social attributes specified by the brand promoter for the brand campaign, possibly indicating that the brand advertising dollars may be better spent elsewhere (e.g. on social publishers having different social attributes).

The SNBAMS 100 may further be configured to price or value the data that may be captured based on how the social publisher interacts with the details of the brand's sponsorship offer (by either selecting or not selecting the sponsorship offer). When a social publisher having social attributes specified by the brand promoter selects a sponsorship offer, this is indicative of a deeper engagement with that social publisher, as the social publisher has taken an affirmative step to be associated with the brand. FIG. 4 is a flowchart showing an example how of the SNBAMS 100 may price or value this level of deeper engagement. The process begins at the initiation block and proceeds immediately to block 400, where the SNBAMS determines that the social publisher has selected a sponsorship offer from the brand promoter. Next, the SNBAMS 100 records the acceptance of the sponsorship offer at block 402. The process then moves to block 404, where the SNBAMS 100 increases the brand selection count for the brand campaign. The brand selection count is the number of times that the brand sponsorship offer has been accepted by social publishers after having reviewed the details of the sponsorship offer. Based on the brand selection count, the SNBAMS 100 then calculates at block 406 the brand selection rate based as the rate at which the social publishers receiving the brand sponsorship offer actually accept the offer.

The SNBAMS 100 may be further configured to identify additional value events within the sponsorship offer selection made by a social publisher. As noted above, the typical sponsorship offer may include various options (referred to as assets) with respect to compensation and brand art which may be selected by the social publisher when they accept a sponsorship offer. The SNBAMS 100 may be configured to record assets' performance among those assets provided in the sponsorship offer are selected by the social publishers. This data provide the brand promoters valuable insight about their brand campaign. For example, if one creative asset (such as a branding logo) is being frequently selected by social publishers having a specified attribute, but another creative asset is ignored, the brand promoters are receiving valuable feedback about the assets from consumers having their specified social attributes. This is advantageous because this feedback is provided and generated without having to go through the expense of rolling out of a large advertising campaign. Instead, the brand promoters are given an indication of which assets are best suited for further exploitation.

The SNBAMS 100 may be further configured to determine a price or value of additional events in the social publisher/brand promoter interaction described in FIG. 2 above. As noted above, when an asset has been selected and adopted by a social publisher, it is integrated with their social media content. The SNBAMS 100 may be configured to capture this event and its value to the brand promoter. The integration of the asset into the social content of a social publisher is valuable not only because the social publisher adopting the asset is exposed to the brand, but also because the brand is exposed to other consumers who visit that page. The other consumers have a relatively high probability of having similar social attributes as the social publisher. As a result, the brand is exposed on the page of the social publisher to other social publishers who may have similar social attributes, providing an “endorsed impression” based on the social influence of the social publisher in the network.

The data gathering processes described above may be performed with respect to each social publisher/brand promoter interaction within the SNBAMS 100. By collecting and generating data with respect to each interaction, a large set of data is made available from which more general observations may be made concerning the performance of brand campaigns within the social networking environment.

In still additional aspects, SNBAMS 100 may be further configured to analyze the gathered data and provide metrics to the brand promoters which detail the brand distribution of their brands within social media. For example, for a particular brand campaign, the endorsed impressions and other data measurements may be integrated into a single metric of “influence garnered” or “influence purchased” throughout the brand's social media campaign. The influence garnered provides a more complete view of the effectiveness of the brand campaign within the social media because it accounts for both the quality of brand impressions and the quantity of brand impressions within the social network.

In one embodiment, the SNBAMS 100 may be configured to determine the influence garnered in a brand advertising campaign based on three data elements collected and determined by the SNBAMS 100 throughout the brand promoter/social publisher interaction process. The three elements in this measurement may be (1) the volume of the endorsed impressions received among all of the social publishers who have accepted sponsorship offers within the brand campaign; (2) the average quality of the publishers providing the endorsement; and (3) the alignment score of the social publishers with specific social attributes.

As briefly noted above, the volume of the endorsed impressions may be the total volume among all social publishers whom have accepted sponsorship offers from the brand promoters. Thus, the endorsed impressions may be spread across the social content of hundreds or even thousand (or millions) of social publisher web pages. The quality of endorsed impressions may be determined by gathering data relating to the social publishers who accepted the sponsorship offer. This data may include in the quality of interactions on the social publisher's website. For example, a higher quality rating may be given to a social publisher having a high percentage of repeat traffic (which suggests that the site visitors are receiving reinforcing brand impressions). The quality measurement may also how long visitors to the sponsored social content remain on the sponsored webpage. A longer average time spent on the sponsored webpage may indicate that the visitors to that page are receiving a more thorough exposure to the brand content.

The quality measurement may be further based at least in part on content safety measurements. For example, the SNBAMS 100 may be configured to determine how long it has been since each social publisher's website has been subject to some form of editorial review. The social content that has been subject to a more recent review may receive a higher quality score. The SNBAMS 100 may also be configured to account for any TOS violations that have been issued to social publishers. Additional factors may also be considered. For example, the SNBAMS may analyze the “friends” list for the sponsored social publishers and determine the “quality” of these friends. For example, if a social publisher's friends list is populated by other social publishers who are popular members of the social network, then the quality score may be increased. Other factor may include the quality of the social network, the quality of the physical location of the social publisher, and other factors.

As noted above, the SNBAMS 100 is configured to match social publishers with brand campaigns based on the social attributes sought by the brand campaigns and display sponsorship offers to those social publishers having the selected social attributes (more details about this process are provided below). The alignment aspect of the “influence garnered” measurement is a measurement of how closely the social publishers who ultimately accept the sponsorship offer from the brand promoter are aligned with the selected attributes. Where the social publishers are more closely aligned, the alignment score will increase. Where the sponsored social publishers are not more closely aligned the alignment score for the brand campaign will decrease. The determination of whether the social publisher is “aligned” with the brand campaign may be based on various factors including, but not limited to, self-selected attributes of publisher as provided to the SNBAMS 100, community tagged attributes of publisher (i.e., how others in the social networking community perceive the social publisher), and other metrics gathered from the system such as the results of prior sponsorships, and automated scanning of the social publisher's social content to determine publisher alignment.

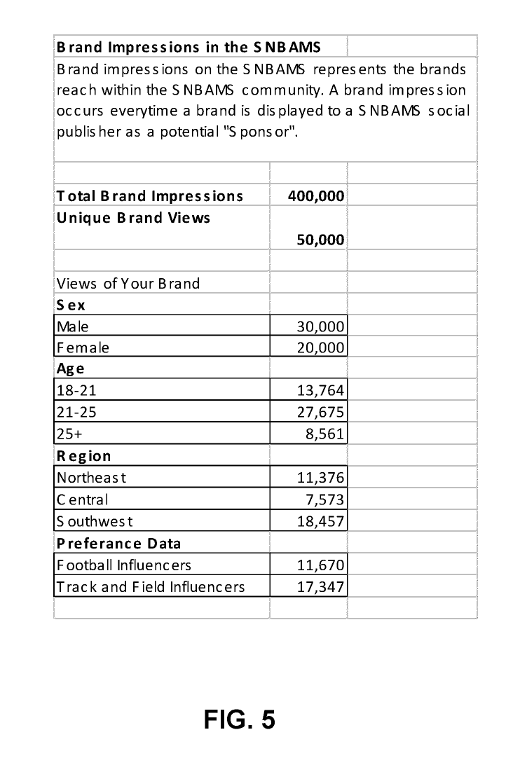

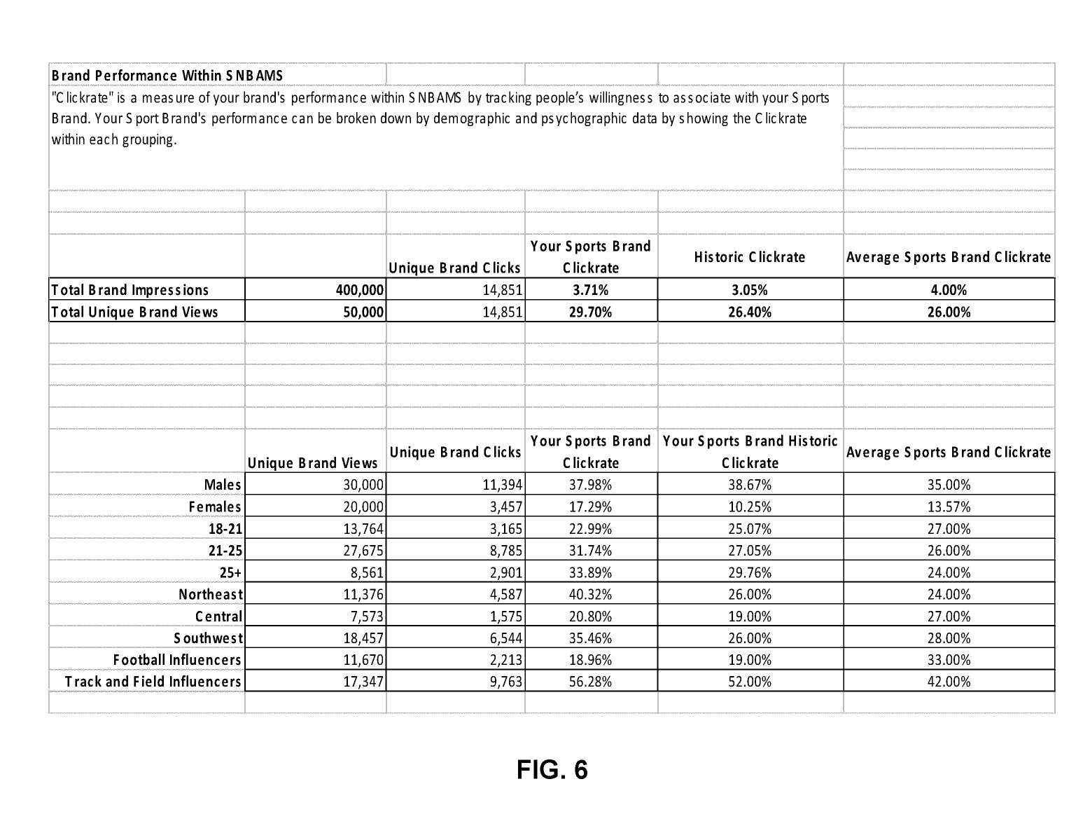

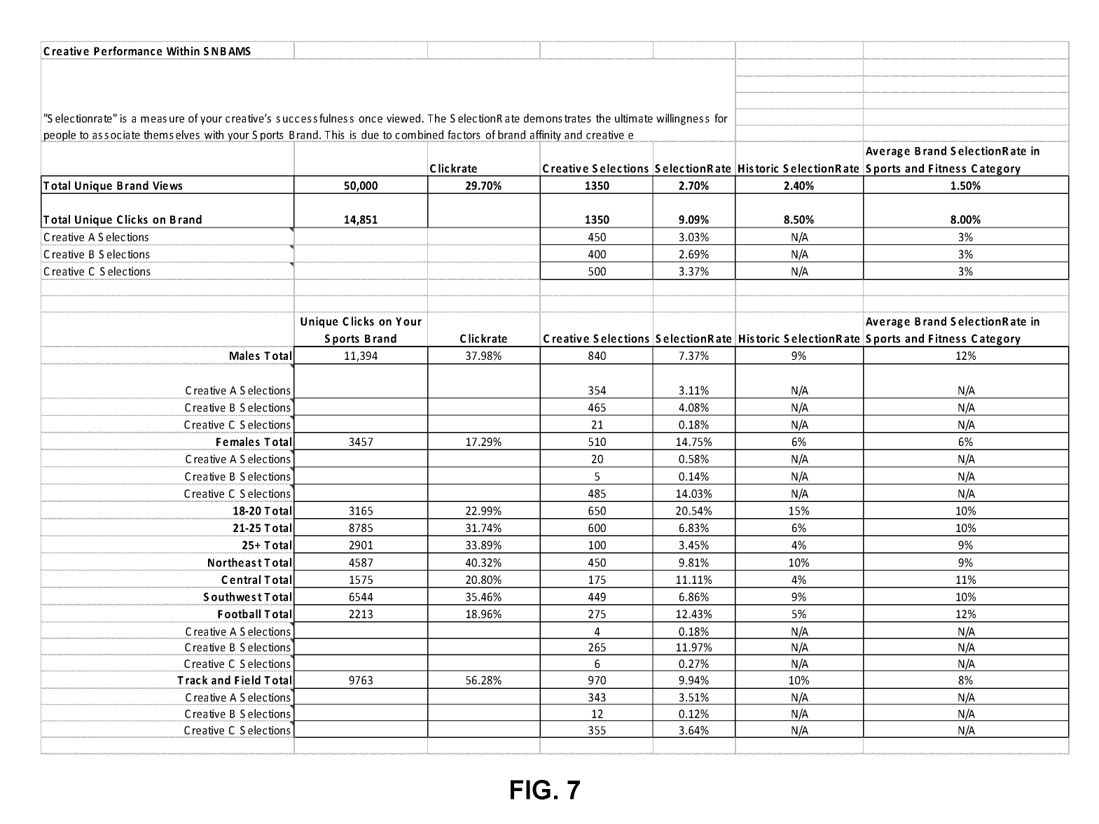

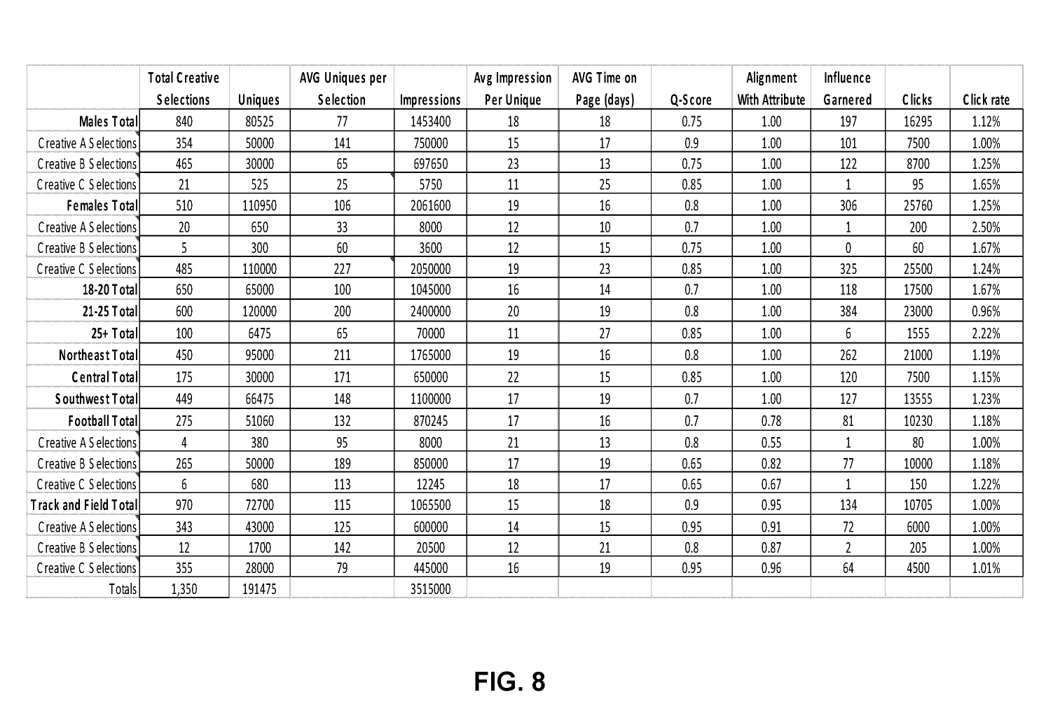

Referring now to FIG. 5, an example is provided of a report that details the activity related to block 200 in FIG. 2 above. This reporting data may be generated and transmitted by the SNBAMS 100 to the brand systems 106 and/or the agency systems 108. The brand promoters associated with the brand systems 106 and/or the agency systems 108 may be charged a fee for receiving this reporting detail from the SNBAMS 100. FIG. 6 is an example of a report that may be generated by the SNBAMS 100 which details the social publishers' brand interaction as described above in connection with blocks 202, 204, and 206 of FIG. 2 as measured by the process described in connection with FIG. 3. FIG. 7 provides an example of a report that may be generated by the SNBAMS 100 which provides details about the social publisher/brand interaction with respect to blocks 208 and 210 (and FIG. 4). FIG. 8 provides an example of an “influence garnered” report that may be provided to brand promoters. Using the systems and methods described above, the SNBAMS 100 provides a platform which allows for brand promoters and social publishers to be integrated into an efficient social media advertising marketplace. Only in this system can each of the value-generating events be identified and quantified on behalf of brand promoters. Thus by utilizing the SNBAMS, brand promoters may be charged based on any or all of the data metrics generated by the SNBAMS 100.

### Examples of Operation

In one embodiment, a brand promoter may specify that they want to target 26 year-old males in California for sponsorships for a particular brand advertising campaign. The brand promoter may specify that they are willing to pay $5 per thousand endorsed impressions for a sponsorship that meets this specification. However, because there may not be enough perfectly aligned potential sponsors willing to accept the sponsorship offer, the SNBAMS 100 may be configured to distribute the sponsorship offer more widely to social publishers not meeting each specified attribute. Those non-aligned publishers may select the offer, but the brand promoter will not be charged the full $5 per thousand endorsed impressions for those non-aligned sponsorships. In addition, as noted above, by determining value at different points in the brand promoter/social publisher interaction as described above, the SNBAMS 100 provides the ability to recognize and account for the fact that different types of brand distributions within a social networking environment may not be equal in value. For example, a brand sponsorship offer accepted by a very popular social publisher may result in a wide distribution, such as 1,000,000 impressions, for example. The value derived from this interaction is mainly associated with the brand impressions delivered via the social content of the popular social publisher. Conversely, if the brand promoter sets forth sponsorship offers to 5,000 different less popular social publishers, 1,000 of whom accept the sponsorship offer, the brand promoter may still gain the benefit 1,000,000 impressions via the social content of the 1,000 sponsored social publishers. However, there is considerable additional value derived and measured via the interactions described in FIGS. 2-4 above. This additional data may provide brand promoters with additional value above and beyond the page impressions alone.

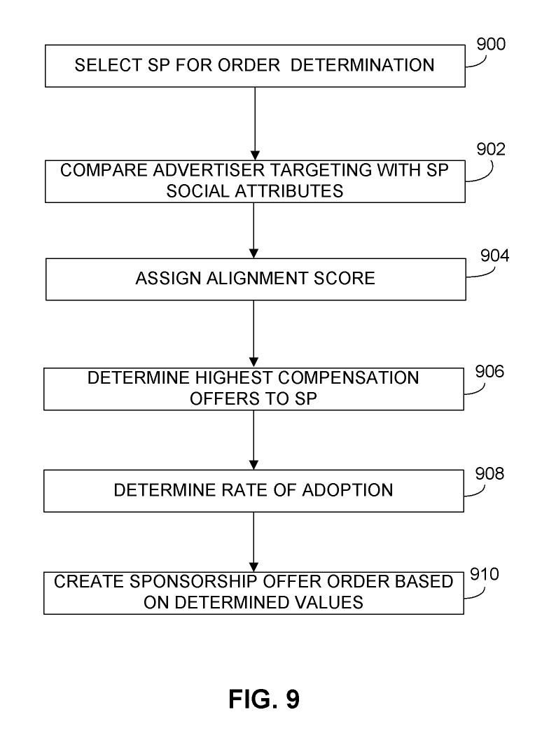

As noted above, sponsorship offers to social publishers may be delivered by the SNBAMS 100. Another aspect of the invention provides systems and methods which provide the ability to optimize the display of sponsorship offers so that social publishers find offers of interest, and revenue generated by the SNBAMS 100 is maximized. FIG. 9 is a flowchart that shows a method for optimizing the display of sponsorship offers within the SNBAMS 100. The method begins at block 900, where SNBAMS 100 selects a specific social publisher for which to determine a sponsorship offer display order. Next, at block 902 the SNBAMS compares the advertiser targeting (e.g., the specified social attributes) for each of the currently active campaign within the system with social attributes of the social publisher. As noted above, the social attributes of a social publisher may be determined in various ways including self-designation, community tagging, system metric gathering, traffic monitoring, etc.

Next at block 904, the SNBAMS assigns an alignment score to the active campaigns based on their alignment with the social publisher attributes. The process then moves to block 906, where the SNBAMS 100 rates the brand campaigns based on the bid price that the brand promoter is willing to pay for an accepted sponsorship for the social publisher. The process then moves to block 908, where for each current brand campaign, the rate of adoption (e.g. brand selection rate) is determined. The rate of adoption is typically based the percentage of social publishers that have accepted the sponsorship offer after reviewing the details of the offer. This feature provides an incentive for brand promoters to provide attractive and interesting creative sponsorship opportunities to social publishers. If the rate of adoption is low, the sponsorship offer is less likely to be displayed to a user among the first few sponsorship opportunities. At block 910, the SNBAMS 100 combines the determined values from above into a composite value for each sponsorship offer, and displays the sponsorship offers to the social publisher based on the composite value. This process may be continuously repeated for each social publisher within the SNBAMS 100 in order to dynamically adjust to changing conditions within the social networking brand marketplace created by the SNBAMS.

Those of skill will recognize that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

It will be understood by those of skill in the art that numerous and various modifications can be made without departing from the spirit of the present invention. Therefore, it should be clearly understood that the forms of the invention are illustrative only and are not intended to limit the scope of the invention. While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention.

What is claimed is:

1. A computer-implemented method of quantifying points of value in a personality relevant publishing environment, the method comprising:
identifying a plurality of social publishers each having social characteristics of interest to a brand promoter;
sending a first message to each of the social publishers, wherein the message comprises data indicative of the brand promoter and an offer to provide details of a brand sponsorship opportunity to each of the social publishers;
storing data indicative of the first message, the data indicative of the first message including the identity of the social publisher receiving the message, social characteristics of the social publisher receiving the message, and the brand associated with the brand sponsorship opportunity associated with the first message;
receiving and storing data indicative of responses the social publishers to the first message, wherein the responses to the first message include data indicative of an acceptance or declination of the offer to provide details of the brand sponsorship opportunity;
sending a second message to those of the social publishers whose response to the first message includes an acceptance of the offer to provide details of the brand sponsorship opportunity, wherein the second message comprises data indicative of the details of the brand sponsorship opportunity;
storing data indicative of the second message, the data indicative of the second message including the identity of the social publisher and the details of the second offer; and
receiving and storing data indicative of responses by the social publishers to the second message, wherein the responses to the second message include data indicative of an acceptance or declination of brand sponsorship opportunity.

2. The computer-implemented method of claim 1, wherein the data indicative of the details of the brand sponsorship opportunity comprises digital assets including social publisher-selectable compensation and one or more available selections of brand art for display within social content of the social publisher.

3. The computer-implemented method of claim 1, further comprising generating metrics based at least in part on the first response from the selected social publishers and the second response from the selected social publishers, wherein the generated metrics comprise a brand interaction count and a brand selection count.

4. The computer-implemented method of claim 3, wherein the brand interaction count comprises data indicative of acceptance by the social publishers of the offer to provide details of the brand sponsorship opportunity.

5. The computer-implemented method of claim 4, further comprising generating data indicative of a brand interaction rate, wherein the brand interaction rate is indicative of the rate of acceptance by the social publishers of the offer to provide details of a brand sponsorship opportunity.

6. The computer-implemented method of claim 3, wherein the brand selection count comprises data indicative of acceptance by the social publishers of the sponsorship offer.

7. The computer-implemented method of claim 6, further comprising generating data indicative of a brand selection rate, wherein the brand selection rate is indicative of the rate of acceptance by the social publishers of the brand sponsorship opportunity.

8. The computer-implemented method of claim 2, wherein the data indicative of acceptance of the brand sponsorship opportunity comprises data indicative of a selection of one or more digital assets by the social publisher.

9. The computer-implemented method of claim 8, further comprising incorporating the selected digital assets into the social content of the social publisher whom made the selection of the one or more digital assets.

10. The computer-implemented method of claim 8, further comprising generating an digital asset performance metric for one or more of the digital assets based at least in part on the rate of selection of the one or more digital assets when one or more of the social publishers indicates an acceptance of the brand sponsorship opportunity.

11. The computer-implemented method of claim 1, further comprising generating an influence garnered metric based on a volume of endorsed impressions received among social publishers who have accepted the brand sponsorship offer, an average quality of the social publishers who have accepted the brand sponsorship offer based on the social content of the social publisher, and an alignment score based on the alignment of the social characteristics of interest to a brand promoter and the social characteristics of the social publishers who have accepted the brand sponsorship offer.

12. A computer-readable medium having computer-executable instructions stored thereon which, when executed, cause a computing device to perform a method of quantifying points of value in a personality relevant publishing environment, the method comprising:
identifying a plurality of social publishers each having social characteristics of interest to a brand promoter;
sending a first message to each of the social publishers, wherein the message comprises data indicative of the brand promoter and an offer to provide details of a brand sponsorship opportunity to each of the social publishers;
storing data indicative of the first message, the data indicative of the first message including the identity of the social publisher receiving the message, social characteristics of the social publisher receiving the message, and the brand associated with the brand sponsorship opportunity associated with the first message;
receiving and storing data indicative of responses the social publishers to the first message, wherein the responses to the first message include data indicative of an acceptance or declination of the offer to provide details of the brand sponsorship opportunity;
sending a second message to those of the social publishers whose response to the first message includes an acceptance of the offer to provide details of the brand sponsorship opportunity, wherein the second message comprises data indicative of the details of the brand sponsorship opportunity;
storing data indicative of the second message, the data indicative of the second message including the identity of the social publisher and the details of the second offer; and
receiving and storing data indicative of responses by the social publishers to the second message, wherein the responses to the second message include data indicative of an acceptance or declination of brand sponsorship opportunity.

13. The computer-readable medium of claim 12, wherein the data indicative of the details of the brand sponsorship opportunity comprises digital assets including social publisher-selectable compensation and one or more available selections of brand art for display within social content of the social publisher.

14. The computer-readable medium of claim 12, further comprising generating metrics based at least in part on the first response from the selected social publishers and the second response from the selected social publishers, wherein the generated metrics comprise a brand interaction count and a brand selection count.

15. The computer-readable medium of claim 14, wherein the brand interaction count comprises data indicative of acceptance by the social publishers of the offer to provide details of the brand sponsorship opportunity.

16. The computer-readable medium of claim 15, further comprising generating data indicative of a brand interaction rate, wherein the brand interaction rate is indicative of the rate of acceptance by the social publishers of the offer to provide details of a brand sponsorship opportunity.

17. The computer-readable medium of claim 14, wherein the brand selection count comprises data indicative of acceptance by the social publishers of the sponsorship offer.

18. The computer-readable medium of claim 17, further comprising generating data indicative of a brand selection rate, wherein the brand selection rate is indicative of the rate of acceptance by the social publishers of the brand sponsorship opportunity.

19. The computer-readable medium of claim 13, wherein the data indicative of acceptance of the brand sponsorship opportunity comprises data indicative of a selection of one or more digital assets by the social publisher.

20. The computer-readable medium of claim 19, further comprising incorporating the selected digital assets into the social content of the social publisher whom made the selection of the one or more digital assets.

21. The computer-readable medium of claim 19, further comprising generating an digital asset performance metric for one or more of the digital assets based at least in part on the rate of selection of the one or more digital assets when one or more of the social publishers indicates an acceptance of the brand sponsorship opportunity.

22. The computer-readable medium of claim 12, further comprising generating an influence garnered metric based on a volume of endorsed impressions received among social publishers who have accepted the brand sponsorship offer, an average quality of the social publishers who have accepted the brand sponsorship offer based on the social content of the social publisher, and an alignment score based on the alignment of the social characteristics of interest to a brand promoter and the social characteristics of the social publishers who have accepted the brand sponsorship offer.
